(19) United States
(12) Patent Application Publication
(10) Pub. No.: US 2026/0089097 A1
(43) Pub. Date: Mar. 26, 2026

(54) NETWORKING PATH SELECTION WITH PATH CLUSTERING

(71) Applicant: Arista Networks, Inc., Santa Clara, CA (US)

(72) Inventors: Venkitraman Kasiviswanathan, San Ramon, CA (US); Saurabh Kumar, Newark, CA (US); Abhijith Kudupu Narayan, Austin, TX (US)

(21) Appl. No.: 18/893,053

(22) Filed: Sep. 23, 2024

(51) Int. Cl. H04L 45/00; H04L 43/08

(52) U.S. Cl. CPC H04L 45/70; H04L 43/08; H04L 45/46

(57) ABSTRACT

Various paths between a networking source and networking destination are identified that have various different associated path metrics. Rather than automatically use all paths or a single path for a route between the devices, a networking device clusters paths according to the respective path metrics to identify paths sufficiently similar to one another. The cluster associated with a preferred path is then determined and the associated paths with that cluster are stored as the paths used for a route between the networking source and networking destination.

### BACKGROUND

This disclosure relates generally to network devices and particularly to selecting paths for a route between networking devices.

In many networking systems, especially large configurations spanning different sites and heterogenous channels (e.g., different service providers, various wired/wireless communication technologies, etc.), a source device may access a destination device across a number of different possible paths. Selecting which paths for networking devices to use may be difficult as different paths may offer different relative characteristics, and additional paths may provide further or parallel ways of reaching the destination. Inefficient path selection can lead to the selection of either insufficient or excess paths leading to suboptimal use of the paths for data transmission.

### BRIEF DESCRIPTION OF THE DRAWINGS

FIG. 1 shows an example networking environment in which networking devices may have several paths for communication between computing devices, according to one embodiment.

FIG. 2 shows components of an example networking device, according to one embodiment.

FIG. 3 shows an example set of paths for reaching a networking destination from a networking source, according to one embodiment.

FIG. 4 is an example representation of path metrics in a 2-dimensional graph.

FIG. 5 shows an example clustering of paths based on a k-means clustering.

FIG. 6 shows an example clustering of paths based on a threshold from a preferred path, according to one embodiment.

FIGS. 7A-D shows an example clustering of paths based on an exploration queue, according to one embodiment.

FIG. 8 shows an example flowchart for determining a set of paths for a route from a networking source to a networking destination, according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

To improve the selection of paths for a particular networking source to a particular networking destination, the possible paths are clustered to identify a cluster of paths that includes a preferred path to the networking destination. Initially, the possible paths are determined to determine the unique set of possible paths from the networking source to networking destination, which may use different ports, a different number and selection of hops (intermediate networking devices), service providers, costs, communication technologies, etc. For each path, a respective plurality of path metrics are also identified, such as the latency, jitter, cost, loss rate, etc., that characterize transmission along each of the paths.

Rather than selecting all paths or applying a static threshold, the paths are selected dynamically based on the characteristics of the paths themselves by clustering the paths based on their characteristics. The clustering may be based on a “preferred” path, by identifying paths having path metrics better than or within a threshold of the preferred path, such that these paths are clustered with the preferred path. The clustering may be performed in various ways including a modified DBSCAN algorithm or k-means clustering. To measure similarity or “distance” when performing the clustering, distance may be evaluated for each of the path metrics individually, or a combined distance may be calculated (e.g., as a weighted combination).

In one embodiment, the clustering is performed by determining a cluster related to the preferred path. In this embodiment, the cluster may initially be defined as the preferred path, and all paths except for the preferred path initially considered as an outlier. Paths may be transitioned from designation as an outlier to a designation with the cluster by evaluating paths in an exploration queue that initially includes the preferred path. In this embodiment, paths in the exploration queue are evaluated with respect to the (remaining) outliers to determine whether any outlier paths are better than or within a threshold for each of the path metrics to the explored path. When an evaluated path (currently designated as an outlier) has all metrics within the respective threshold distances (or better) of the metric for the explored path, the outlier path is considered a member of the cluster, added to the cluster list, removed from the outlier list, and added to the exploration queue, such that paths can be added to the cluster when they are sufficiently close to a path currently in the cluster (and being explored). In this embodiment, the preferred path can thus be used to seed exploration of a cluster of sufficiently similar paths.

The set of paths in the cluster with the preferred path may then represent a group of paths with sufficiently similar characteristics and may be used for routing from the network source to the network destination. The group of paths are then stored in the communication routing table for the network source and used for data transmission by the network source.

In various embodiments, the parameters for selecting a preferred path and clustering the paths may also be determined based on a policy and/or application type. For example, voice communication may optimize for low jitter and latency, but be relatively insensitive to cost or bandwidth compared to backup data transmissions, which may prefer available bandwidth and be relatively insensitive to jitter and latency. In some embodiments, the selection of paths and parameters may be automatically determined, such that optimal paths may be selected without administrator configuration. By identifying clusters of paths with the preferred path, an optimized set of paths is selected that allows for dynamic selection of paths that reduce reliance on a single path without overly allowing suboptimal paths.

### System Environment

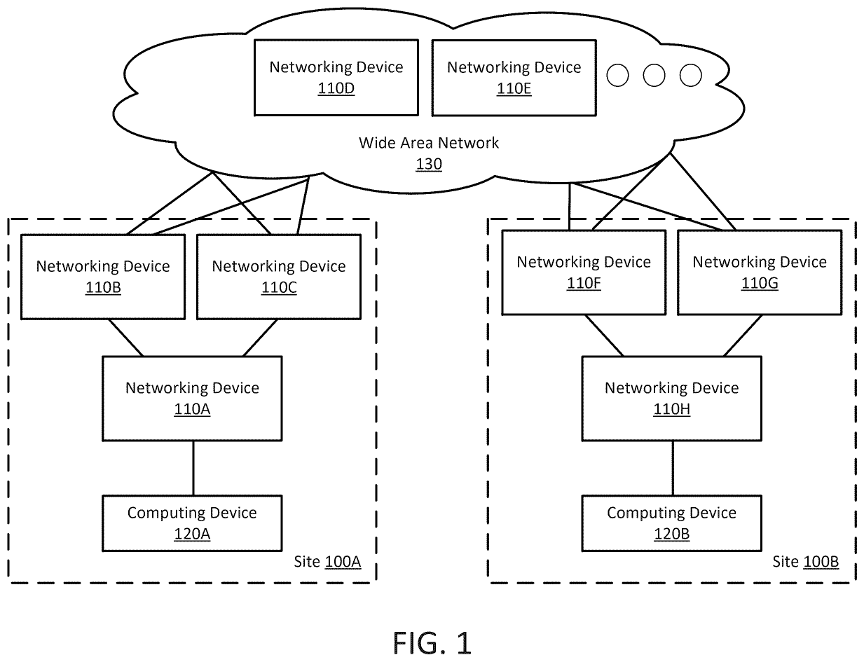

FIG. 1 shows an example networking environment in which networking devices may have several paths for communication between computing devices, according to one embodiment. In the example of FIG. 1, various networking devices 110A-H may communicate with one another to provide communication between a variety of computing devices such as computing devices 120A-B. In this example environment, the computing devices 120A-B are connected to respective networking devices 110A, H. To send messages between networking devices 110A, H, a variety of different paths may be used. Different paths may have a different number of hops, use different ports, communication channels, methods, service providers, and so forth. Each path may thus represent a unique sequence of devices and/or ports for reaching a networking destination from a networking source. As discussed further below, paths may be selected for use between a networking source and networking destination by clustering paths according to associated path metrics, such that the selected paths have sufficiently similar path metrics and allows for the selection of additional paths beyond a “best” without including paths that would not be clustered with the preferred path.

The networking devices and related processes discussed herein may also be applied to different networking configurations and architectures, such that the particular arrangement shown in FIG. 1 shows one example architecture in which these approaches may be applied. In general, the networking devices 110A-H provide various network switching and routing services between various computing devices 120 and may provide networking services with L2 and/or L3 network addressing (e.g., including handling with Media Access Control (MAC) and Internet Protocol (IP) addresses). The different computing devices 120 communicate with packets including a payload for delivery and header information describing various information for handling processing of the packet during network communication, which may include information about the source, destination, sequence information, priority information, data type, and so forth. Although a number of components such as networking devices 110A-H and computing devices 120 are shown in FIG. 1, in practice, any number of these devices may be included in various configurations, which may be private networks and include connections to external networks, such as the Internet.

In the environment of FIG. 1, each networking device 110A, H is connected directly to respective computing devices 120A, B. The connected computing devices 120A, B of each networking device 110A, H represent the local computing devices for the respective networking devices. In this example, the computing device 120A is connected locally (i.e., directly) to networking device 110A, and computing device 120B is connected locally to networking device 110H. The networking devices 110 may be configured in various networking architectures, such as a spine and leaf architecture in which networking devices 110 operating as a “leaf” (e.g., networking devices 110A, H) connects to other leaf devices and other external systems via a set of spine networking devices (e.g., via networking devices 110B, C and networking devices 110F, G). Groups of computing devices 120 and networking devices 110 may be physically located at individual sites 100 and may communicate with one another across a wide area network (WAN) 130 that may include access to or paths through additional networking devices 110, such as networking devices 110D, E.

Each site 100 may provide various different links or connections to the wide area network 130, each of which may be provided by a different service provider and may have different characteristics. As such, in one embodiment of the disclosure, the network may include any combination of local (e.g., local area network (LAN) and/or WAN segments that may be wire-based and/or wireless and that may use any combination of wired and/or wireless communication protocols). The connections to the wide area network 130 (and transmissions thereon) may be coordinated by various service providers and may include private (e.g., multiprotocol label switching (MPLS) providers) and public (e.g., internet service providers (ISPs)) service providers. In this example, the networking devices 110B, C of site 100A each have two connections to the wide area network 130. Paths having a networking source from the site 100A may thus exit the site 100A from either networking device 110B, C and from each of the separate connections to wide area network 130.

As such, in various embodiments, the networking devices may be conceptually (and in some cases explicitly) organized hierarchically, such that devices may manage communications for a particular domain that are dispersed across different regions (e.g., continents, countries, or states) having one or more sites (e.g., physical computing centers). In some examples, certain networking devices may operate as relays/hubs that connect individual sites with service providers that connect networking devices within the site with the WAN. In the example of FIG. 1, networking devices 110B, C may operate as a hub for site 100A and networking devices 100F, G may operate as a hub for site 100B.

In various embodiments additional networking components may also be included that are not shown in FIG. 1, such as networking controllers, route reflectors, and other centralized devices that may assist in providing management of networking devices 110 at various sites. For example, networking devices 110D or 110E may communicate with the networking devices at each site to coordinate and monitor various networking features across various sites 100, such as route generation or discovery, policy dissemination, or to construct an underlay network.

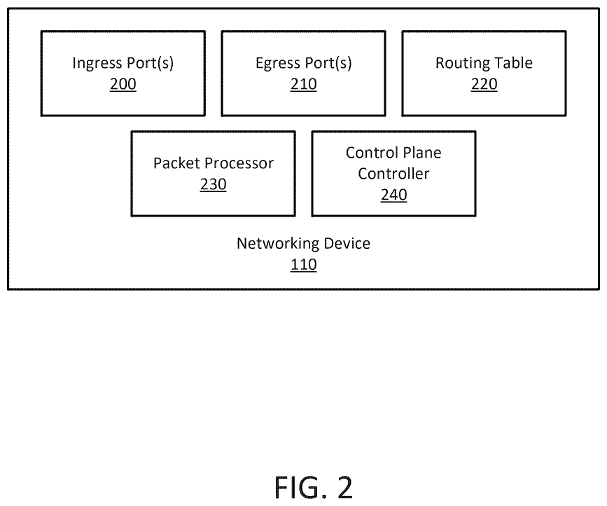

FIG. 2 shows components of an example networking device 110, according to one embodiment. In practice, implementations of the networking device 110 may include more or fewer components than shown in FIG. 2, such as additional control plane and data plane components. In addition, the components shown in networking device 110 may be generally implemented in hardware or other specialized circuits to optimize delivery and processing speed and capability of the networking device 110 and the overall network formed by the networking devices. Embodiments of the networking device 110 may implement additional capabilities than those expressly discussed herein.

Each networking device 110 may include a number of ingress ports 200 at which packets are received by the networking device 110 for switching and forwarding through the network. The networking device 110 processes the packet with a packet processor 230 to identify an egress port 210 for the packet. The packet processor may determine a respective egress port for a packet based on, for example, a destination address in a packet header in conjunction with a routing table 220. The packet processor may perform various additional processing tasks before sending packets to the egress ports 210 such as modifying, adding, or removing header(s) of the packets (e.g., to modify MPLS labels, modify networking or hardware addresses, encapsulate packets to tunnel between devices, and so forth).

Particularly, the routing table 220 may include one or more paths that together form a route from the source networking device 110 to a destination networking device 110. More generally, an address that a path begins is referred to herein as a networking source, and an address that a path ends is referred to as a networking destination. When the route is installed at a particular routing table 220 for processing packets at the networking device 110, the networking source is typically the address of the networking device 110 on which the route is installed. Each route may include one or more paths that may be selected by the packet processor 230 for particular packets based on a path selection algorithm. For example, the path selection algorithm may select a particular path in various ways according to the configuration of the packet processor 230, type of traffic, settings of the route, path congestion, and so forth. For example, the path selection may use a preferred path exclusively until a criteria (e.g., degraded performance or the path is unavailable) occurs, or the paths may be used in parallel such that the paths for particular packets may change depending on the frequency of use of the various paths.

A control plane controller 240 determines information for operation of the packet processor 230 and stores relevant information in the routing table 220 that is used by the packet processor 230. The control plane controller 240 may communicate with various other networking devices 110 for obtaining information about available network destinations, routing/path information, and so forth. Particularly, the control plane controller 240 may determine possible paths from the networking device to a networking destination and determine path metrics associated with a particular path to a networking destination. As discussed below, the control plane controller 240 may then select a subset of the paths based on the path metrics to program in the routing table 220. In one or more embodiments, a path in the routing table 220 may include the set of network devices and individual links (e.g., the specific ingress/egress port of a network device) connecting the network devices. In one or more embodiments, the path may comprise an ordered set of local links for each network device that the path traverses.

Initially, the control plane controller 240 may obtain various paths to a destination through various means, such as by exchanging reachability information with other devices on the network, such as via border gateway protocol (BGP) requests. In some configurations, paths between different devices may also be coordinated in conjunction with a route reflector or route controller that may consolidate and/or centralize information about the network as a whole. For example, in some configurations, one-hop paths between devices may be determined by the respective devices, while multi-hop paths may be determined by a network controller/route reflector based on one-hop paths reported by network devices. In some circumstances, multi-hop paths may be determined by aggregating information about the respective direct paths between directly-connected devices. For example, path metrics for a two-hop path for a networking source to reach a networking destination through an intermediate device may be determined by aggregating path metrics for 1) the networking source to reach the intermediate device and 2) the intermediate device to reach the networking destination. When there are different links that directly connect devices (e.g., devices may be connected via separate ports), a distinct path may be identified for each unique permutation of links.

In one or more embodiments disclosed herein, the path metrics of the path information may include information specifying one or more properties of the path that reflects a quality of that path. For example, the path metrics may include, but are not limited to: latency, jitter, loss, total bandwidth, and current utilizations, etc. In one or more embodiments, the path metrics of each path in the network may be obtained using in-band (e.g., measured properties of a path are piggy backed on existing network traffics) and out-of-band techniques (e.g., synthetic probes with difference quality of service (QOS) marking for measuring latency, jitter, loss, etc.). The path metrics may be determined for each path between the networking source and networking destination. The control plane controller 240 thus determines the various paths between networking source and destination and determines respective path metrics for each path between the networking source and networking destination.

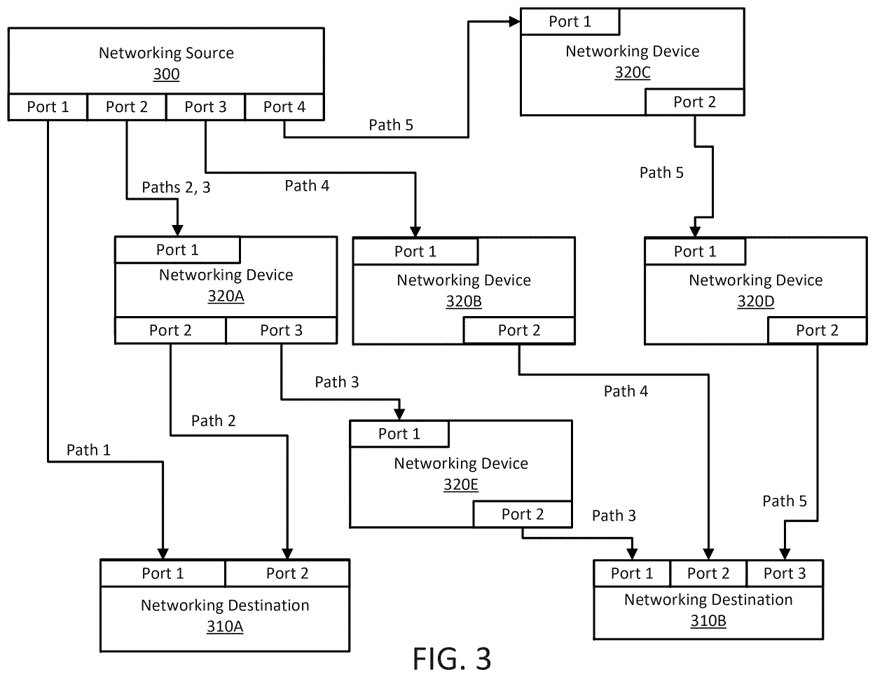

FIG. 3 shows an example set of paths for reaching a networking destination 310 from a networking source 300, according to one embodiment. In this example, the networking destination is an “anycast” networking address, such that the networking destination (correctly) resolves to more than one device. For example, in larger WAN deployments that may span large geographical areas, multiple devices/sites may be configured to provide an application or service (e.g., handling database access requests) accessible by the same networking destination.

However, when identifying paths to reach these networking destinations, such paths may also identify paths that in practice access different devices. As such, in FIG. 3, networking source 300 identifies paths to a networking destination 310. The networking destination 310 sought by the networking source 300 is accessible at different devices, such that some paths, designated path 1 and path 2, reach a device having the networking destination 310A and other paths, designated path 3, 4, and 5 reach a device having the networking destination 310B. That is, the networking destination 310A and networking destination 310B may have the same address, but which are located on different devices and may be accessible via different paths. For example, the networking destination may represent an access point for a database replicated at different geographical regions, such a path to any geographical region (at different networking devices) provides access to the database. From the perspective of the networking source 300, the different devices having the same networking destination may simply be different paths to equally valid destinations.

In the example of FIG. 3, there are five paths illustrated between the networking source and the destination. Each path provides a different combination of links (e.g., using different ports) for accessing the networking destination 310 from the networking source 300.

Certain paths also pass through one or more of the networking devices 320A-E. Path 1 is a direct path from the networking source 300 to the networking destination, while other paths are multi-hop paths. The separate paths are:
Path 1. The networking source 300 uses port 1 to networking destination 310A.
Path 2. The networking source 300 uses port 2 to networking device 320A; networking device 320A uses port 2 to networking destination 310A.
Path 3. The networking source 300 uses port 2 to networking device 320A; networking device 320A uses port 3 to networking device 320E; networking device 320E uses port 2 to networking destination 310B.
Path 4. The networking source 300 uses port 3 to networking device 320B; networking device 320B uses port 2 to networking destination 310B.
Path 5. The networking source 300 uses port 4 to networking device 320C; networking device 320C uses port 2 to networking device 320D; networking device 320D uses port 2 to networking destination 310B.

As shown by the various paths in FIG. 3, various different combinations of links may be available from a particular networking source to a networking destination. As discussed above, the links may also have different characteristics such as different types of communication channels/protocols, wired/wireless links, service providers, and so forth. In addition, each of the paths may be measured with various path metrics that may differ between the various paths. The path metrics may include latency, jitter, loss, etc. as discussed above. When considering one path with another, one path may be comparatively better in one path metric and worse in another.

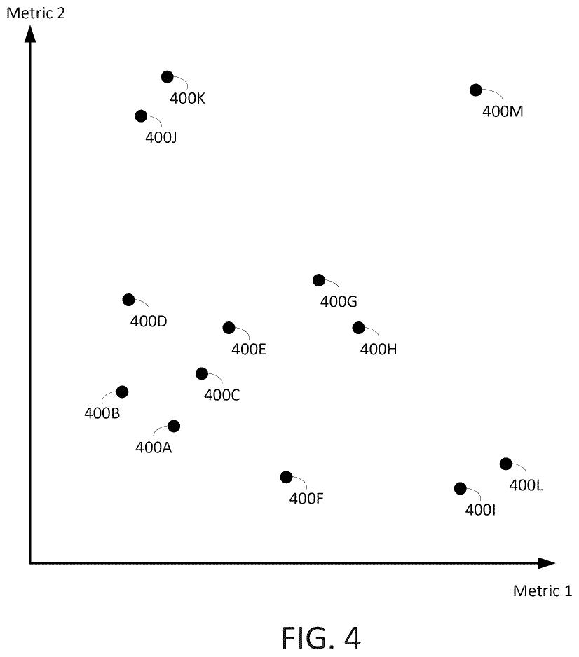

FIG. 4 is an example representation of path metrics in a 2-dimensional graph. In the example of FIG. 4, the path metrics include two metrics, labeled “metric 1” and “metric 2” that represent a first and second path metric. For example, the first path metric may be latency and the second path metric may be jitter. Each point in the graph represents the respective path metrics for various paths 400A-M. In the example of FIG. 4, lower values for the path metrics are considered preferred, such that points closer to the origin of each metric are preferred. As shown in FIG. 4, the particular values of the different path metrics may vary and there may or may not be paths that are better or worse for all path metrics. In this example, path 400A and path 400B may each be a “better” or “preferred” path, depending on whether metric 1 or metric 2 is prioritized. However, path 400A has lower (i.e., better) path metrics than path 400C for both metrics illustrated in FIG. 4. Similarly, Path 400I has the lowest (best) score for metric 2, but a relatively high score (comparatively poor) for metric 1.

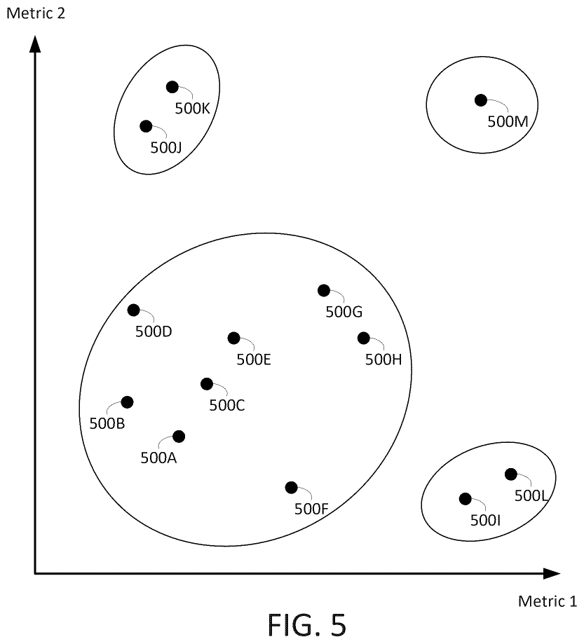

In various network configurations, different paths may be more or less similar to one another when considered across the plurality of metrics. For example, while path 400B may be sufficiently similar to the preferred path 400A, path 400I may be too different with respect to metric 1 (although it has a better score for metric 2), given the other alternative paths, for inclusion in the set of paths used for the routing table. The graph of FIG. 4 illustrates all “possible” paths that may be available from a networking source to a networking destination. To more effectively select paths to form a route, rather than selecting all paths (or a predefined number of “best” paths), the paths selected for the route are selected based on a clustering of the paths according to the path metrics. The particular clustering algorithm may vary in different embodiments, and may include k-means clustering, clustering based on a threshold from a “preferred” path, and iterative clustering as discussed with respect to FIGS. 5-7D. For convenience, paths having the same path metrics are similarly labeled in FIGS. 4-7D, such that paths 400A-M, 500A-M, 600A-M, and 700A-M have the same path metrics as illustrated in the respective graphs.

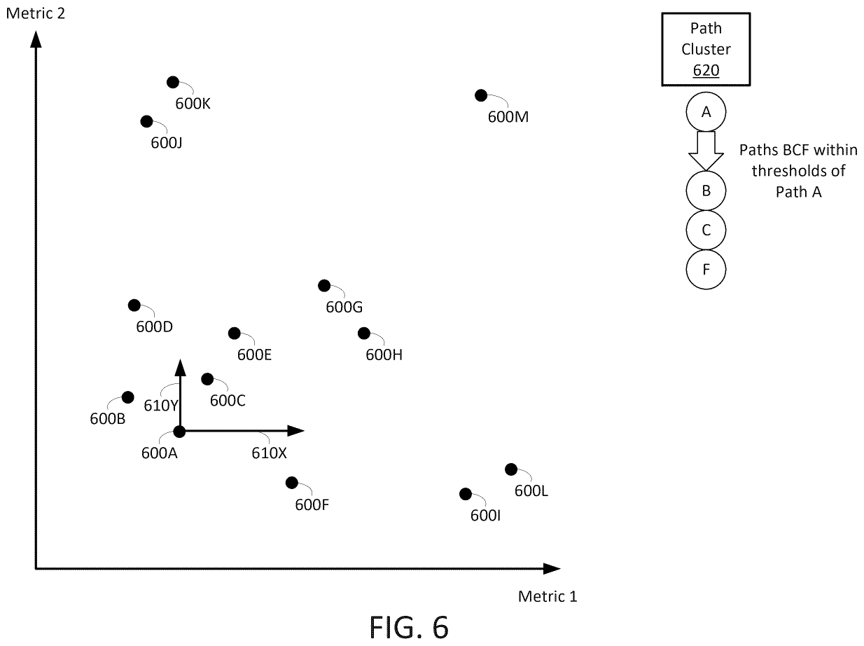

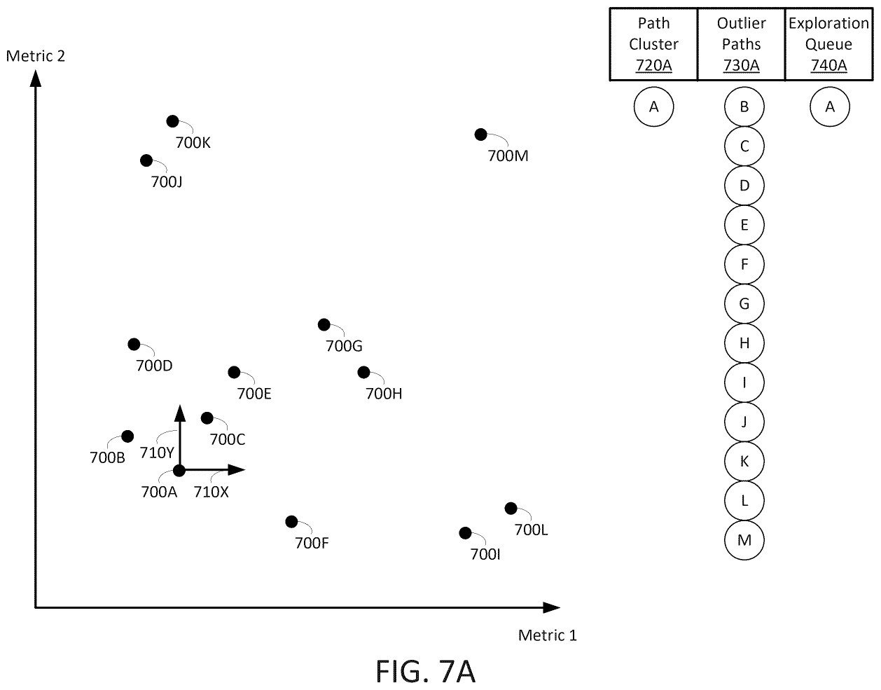

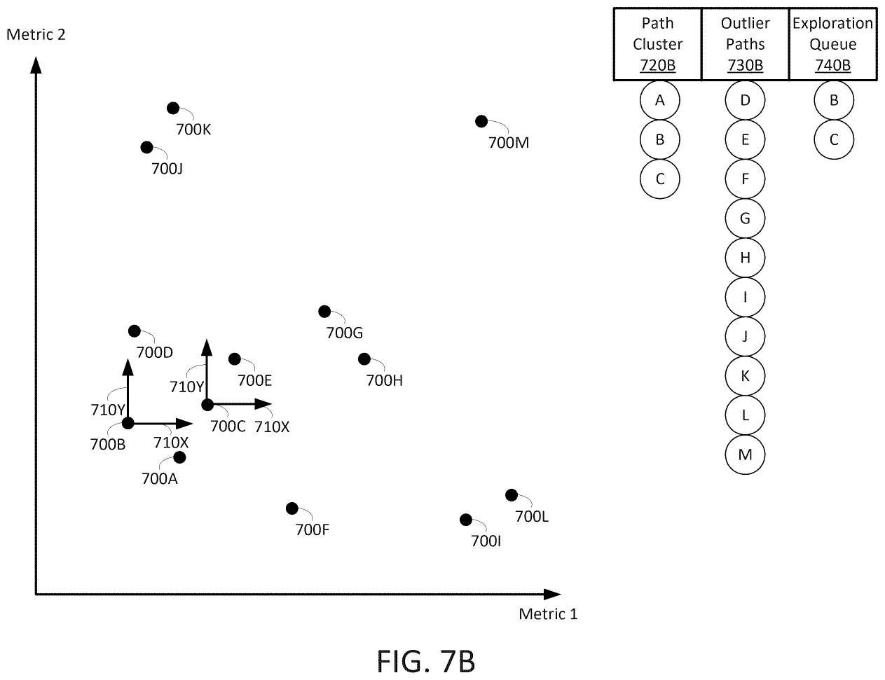

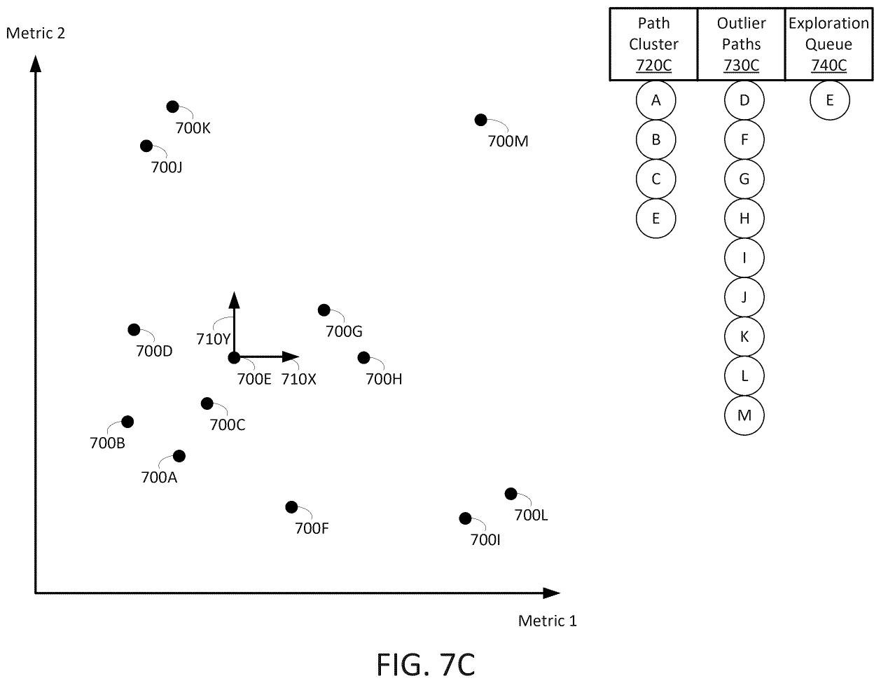

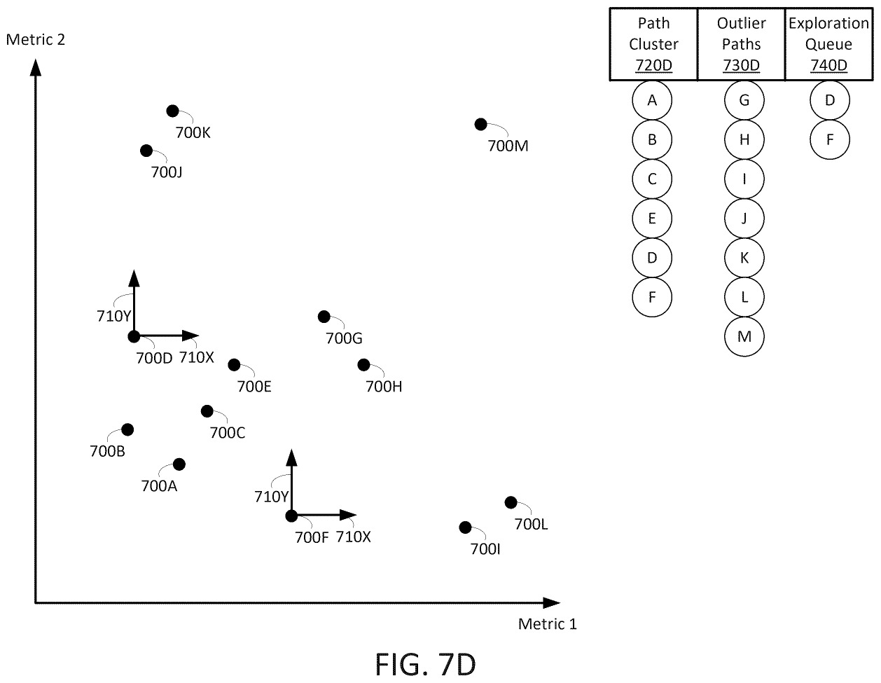

As discussed below, a “preferred” path may be identified and the cluster that the preferred path is a member of. In the examples below, the preferred path is path 400A and respectively path 500A in FIG. 5, path 600A in FIG. 6, and path 700A in FIGS. 7A-D. The set of paths associated with the cluster of the preferred path is then used as the route for the networking source to the networking destination. In general, by clustering paths according to path metrics, the paths selected for the route may thus exclude paths that “significantly” differ from the preferred path, such that additional paths can be included for the route that are sufficiently similar to the preferred path as determined empirically by the clustering process. By clustering the paths, paths for the route may be selected based on the clusters and thereby flexibly account for the different number of available paths and their variation across a plurality of path metrics. Accordingly, depending on the distribution of the paths and respective path metrics, in various instances, the selected paths in the cluster may include many of the possible paths (e.g., if the paths are tightly coupled with respect to the path metrics) and may include relatively few when a limited number of paths have similar path metrics to the preferred path.

FIG. 5 shows an example clustering of paths based on a k-means clustering. In the example of FIG. 5, a k-means clustering algorithm is applied that uses a distance function between path metrics to determine cluster membership. The distance function used for the k-means clustering may evaluate one or more of the path metrics, and may include, for example, a distance based on a linear combination of the difference between the respective plurality of path metrics. The weight for each path metric may be adjusted to affect the significance of that path metric in the clustering algorithm.

In this example, the number of clusters is 4. In various embodiments, the number of clusters (“k”) may be determined automatically by various means (e.g., comparative results between evaluating a different number of clusters). In this example, paths 500A-H are clustered together in one cluster, paths 500J-K are in a second cluster, paths 500I-L are in a third cluster, and path 500M is in a fourth cluster. In this example, the path 500A is the preferred path, such that the paths associated with the first cluster are selected for the route. Specifically, paths 500A-H belong to the cluster and may be selected as the paths used for the route.

FIG. 6 shows an example clustering of paths based on a threshold from a preferred path, according to one embodiment. In the clustering approach of FIG. 6, a path cluster 620A may be determined based on a threshold distance 610 of a path's path metrics relative to the path metrics of the preferred path. The threshold distance 610 may be specified differently for each metric, such that a threshold distance 610X for metric 1 may be different than a threshold distance 610Y for metric 2. In general, the metrics also do not share the same units; for example, latency may be measured in micro or nano seconds, while packet loss may be measured as a percentage or portion of lost packets. In this approach, the preferred path may be identified and selected as the initial member of a path cluster 620. Thus, initially, the path cluster 620 may include only the preferred path, path 600A.

In this clustering approach, for each path metric, the value of the path metric for the preferred path may be added to the respective threshold for the path metric and compared with the value of the evaluated path. When each path metric for an evaluated path is “better” than the preferred path's metric plus the threshold, the evaluated path may be considered to be sufficiently similar to the preferred path and added to the path cluster 620. That is, for inclusion, all path metrics of an evaluated path are within the respective thresholds of the preferred path. Each of the other paths are compared to the preferred path and evaluated for inclusion based on the respective path metrics and applicable per-metric thresholds 610. In the examples below, a “lower” path metric is preferred, such that the threshold may be added to the path metric of the preferred path, and evaluated paths having a path metric below the result are included. Conversely, in embodiments where a higher value for the path metric is preferred, paths having lower values of the path metric, within the threshold of the preferred path, are included in the path cluster.

In the example of FIG. 6, paths 600B, 600C, and 600F are within the thresholds 610X-Y of the preferred path 600A. Specifically: path 600B has a better path metric for metric 1 than preferred path 600A, and metric 2 is within the threshold 610Y of the preferred path 600A. Similarly, path 600F has a better path metric for metric 2 than preferred path 600A and is within the threshold 610X for metric 1 of the preferred path 600A. Finally, path 600C has path metrics higher than path 600A for both metrics 1 and 2, but metric 1 for path 600C is within the threshold 610X of path 600A and metric 2 is within the threshold 610Y of path 600A. This clustering process may emphasize similarity of the paths with respect to the preferred path as measured by the per-metric thresholds. In this clustering algorithm, the path cluster 620 includes paths A, B, C, and F. These paths may then be selected as the paths for the route for the respective networking source and networking destination.

FIGS. 7A-D shows an example clustering of paths based on an exploration queue, according to one embodiment. In the clustering algorithm of FIGS. 7A-D, the paths may be iteratively added to a path cluster 720 as paths are evaluated from an exploration queue 740. Paths that are not (currently) part of the path cluster 720 are considered outliers and designated a set of outlier paths 730. As the algorithm evaluates paths, paths added to the path cluster are also added to an exploration queue 740. Each path in the exploration queue is explored by evaluating the explored path with respect to the outlier paths 730 to determine whether any paths in the outlier paths 730 are sufficiently similar to the explored path. The similarity of the explored path to an outlier path may be evaluated based on per-metric thresholds 710 and may operate similar to the per-metric thresholds discussed with respect to the preferred path-based clustering of FIG. 6. When an evaluated path is sufficiently similar to the explored path, the evaluated path is added to the path cluster 720, removed from the outlier paths 730, and added to the exploration queue 740. After exploring a path (e.g., evaluating all outlier paths relative to the explored path), the explored path is removed from the exploration queue 740. When the exploration queue is empty, the clustering algorithm ends and the resulting set of paths in the path cluster 720 may be used as the paths for the route.

FIGS. 7A-D illustrate this clustering process with threshold 710X for metric 1 and 710Y for metric 2 . In the example of FIGS. 7A-D, path 700A is the preferred path, such that the clustering initially begins in FIG. 7A by adding path A to the path cluster 720A and the exploration queue 740A. The remaining paths B-M are added to the outlier paths 730A. A first exploration may then be performed with respect to path 700A as the explored node from the exploration queue 740A. The explored node (here, path 700A) is compared to each of the outlier nodes to identify outlier nodes having path metrics within the respective per-metric thresholds of the explored path. When exploring path 700A, paths 700B and 700C are within the thresholds 710X and 710Y of path 700A.

FIG. 7B shows the updated resulting state after exploration of path 700A. Paths 700B, C are added to the exploration queue 740B and the path cluster 720B and removed from the set of outlier paths 730B. After exploration of path 700A and evaluation of the outlier paths, path 700A is removed from the exploration queue 740B. The exploration queue 740B now has additional paths to explore. Path 700B is explored, and no nodes in the outlier paths 730B are within thresholds 710X-Y of path 700B. Path 700B is then removed from the exploration queue 740B. Path 700C is explored and the outlier paths 730B are each evaluated with respect to explored path 700C, resulting in the identification of path 700E within the thresholds 700E of explored path 700C.

After exploring path 700C, FIG. 7C shows the addition of path 700E to the path cluster 720C, removal from outlier paths 730C, and addition to the exploration queue 740C. After exploration of paths 700B and 700C, these paths are removed from the exploration queue. FIG. 7C shows exploration of path 700E with respect to the outliers 700C. Paths 700D and 700F are within the respective path metric thresholds 710X-Y of path 700E. As shown in FIG. 7D, paths 700D and 700F are added to the path cluster 720D and exploration queue 740D and removed from outlier paths 730D. After exploration of path 700E, it is removed from the exploration queue 740D.

Finally, exploration of nodes 700D and 700F against the outlier paths does not provide any additional paths within the thresholds 710X-Y for the respective path metrics. After exploring these paths, they are removed from the exploration queue 740D and the exploration queue is empty, after which the algorithm stops. The resulting path cluster 720D indicates the paths in a cluster with the preferred path 700A, including paths A-F in this example. By using this approach, the path clustering was able to identify paths 700F and 700D that have certain individual path metrics better than path 700A without excess loss with respect to others (i.e., they are still sufficiently close for identification with iterative clustering).

Because the exploration process may mean that nodes can iteratively explore the path metrics, the values selected for thresholds 710 may typically be smaller than the metrics used for the single-shot approach of the preferred path algorithm of FIG. 6. That is, although the iterative approach of FIGS. 7A-D permits exploration from the preferred path 700A, an excessively high value for the thresholds 710X-Y may cause the number of included paths to “daisy chain” excessively. As such, in one embodiment, the value of the per-metric thresholds may be modified as the number of explored paths (i.e., a number of iterations) increases. For example, the per-metric thresholds may be decreased (i.e., decay) as additional nodes are explored that are “further” from the preferred path, such that clusters can be generated without allowing excessive degradation of path metrics in selected paths.

In various embodiments, different algorithms, parameters, or settings may be used for clustering and/or the identification of a preferred path. These different configurations may also be specified by various policies, for example for different applications (e.g., application types), traffic classes, combination of source and destination, and so forth. For example, the per-metric thresholds for selecting paths for a real-time voice application (e.g., a voice-over-IP (VoIP) call) may prioritize latency and jitter by setting the threshold for clustering with respect to these path metrics relatively low (i.e., causing reduced clustering from the preferred path in these dimensions). Similarly, per-metric thresholds for data backup may prioritize bandwidth capability or transmission cost, such that per-metric thresholds are relatively lower for these applications. As such, different clustering and selection of preferred paths may be performed depending on the particular properties of the data processed by the networking device (i.e., policy, application type, etc.), resulting in different selections of paths for routing different types of data. In these embodiments, the paths selected to be stored in the routing table may be stored in the routing table in association with the applicable properties, such that traffic with the matching properties (e.g., traffic class) uses the applicable paths in the routing table.

In addition, the parameters for selecting a preferred path and/or clustering may also be automatically determined. In one or more embodiments, certain path metrics may be considered preferred for particular traffic classes (or on another basis) as a default for selecting a preferred path for that traffic class. For example, selection of a preferred path for a class related to VoIP traffic may prefer latency and jitter, while selection of a preferred path for a class related to data backup may prefer bandwidth capability or transmission cost. Similarly, a default value for each metric may be used as a threshold for evaluating path outliers. In additional embodiments, the thresholds for evaluating per-metric similarity may be based on the value of the path metric for the current cluster, such as the value of the path metric for the preferred path. The threshold for per-metric similarity may be set to, for example, a percentage, such as 5%, 10%, or 20% of the value of the metric for the preferred path. These automatic settings may further enable effective path selection without express administrator action.

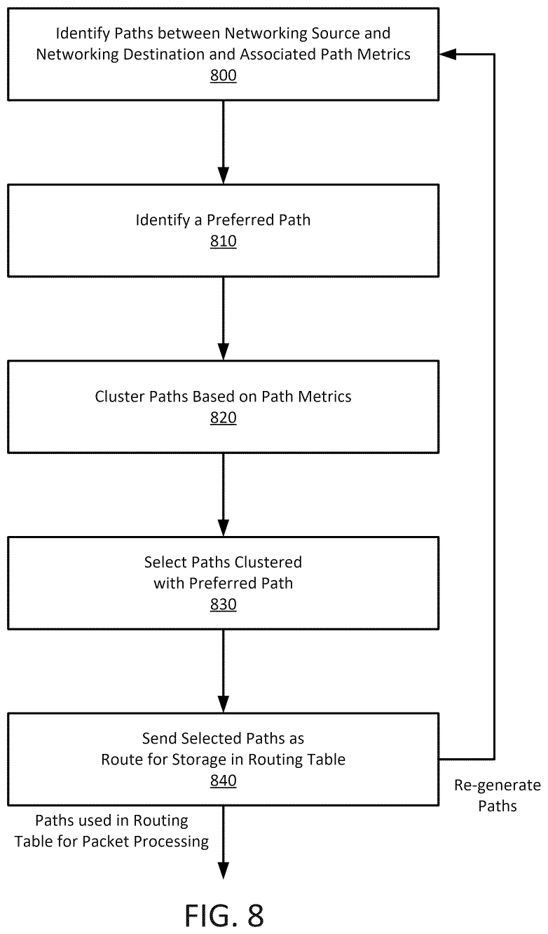

FIG. 8 shows an example flowchart for determining a set of paths for a route from a networking source to a networking destination, according to one embodiment. The process of FIG. 8 may be performed by a networking device (e.g., by the control plane controller 240 of FIG. 2) and may be performed by a networking device having an address of the networking source/destination, or may be performed by a route reflector or other centralized networking control system.

Initially, the paths between a networking source and networking destination are identified 800, along with the associated plurality of path metrics for each of the paths. The identified paths may include all possible paths to the networking destination eligible for evaluation and selection for the routing table. As discussed above, the paths may be identified with various technologies, such as Border Gateway Protocol (BGP) requests distributed to connected networking devices or to relevant route reflectors. Similarly, path metrics may be collected with in-band or out-of-band methodologies as discussed above.

The various identified paths may then be evaluated to identify 810 a preferred path, such as a path having a lowest value of a particular type of path metric (e.g., the path with the lowest latency). The various paths are then clustered 820 based on the path metrics according to a clustering algorithm, such as the algorithms discussed above. The cluster associated with the preferred path is identified and paths are selected 830 that are clustered with the preferred path. The selected paths are then sent 840 for storage in an applicable routing table as the route to be used for packet processing for the networking source and networking destination. In some embodiments, the selected paths may be sent from a route reflector or other centralized location for installation at a local networking device (i.e., associated with the networking source).

Over time, the path metrics may change, additional paths may become available and paths may become unavailable. As such, the process may be repeated to re-generate a set of selected paths for the route after a condition occurs, such as an amount of time passing or a change in the network topology.

By selecting paths based on clustering of path metrics, the selected paths can dynamically change as network conditions change and allow selection of paths that are sufficiently similar to a preferred path without specifying a number of paths to be identified. In addition, the clustering permits identification of “similar” paths to the preferred path that may be based on relative differences in path metrics, such that the preferred path and those sufficiently similar to it can be used for the route.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope, which is set forth in the following claims.

What is claimed is:

1. A method performed for programming a route in a networking system for:
identifying a plurality of paths from a networking source to a networking destination, each path having an associated plurality of path metrics;
determining a preferred path for the networking source to the networking destination based on the plurality of path metrics associated with the preferred path;
clustering the plurality of paths to one or more path clusters based on the respective plurality of path metrics of the respective plurality of paths;
identifying a cluster having the preferred path and a set of paths associated with the cluster; and
sending the set of paths associated with the cluster for storage in a routing table of a networking device associated with the networking source for sending packets to the networking destination.

2. The method of claim 1, wherein the clustering is performed with a k-means algorithm.

3. The method of claim 1, wherein the clustering is based on a per-metric distance function.

4. The method of claim 1, wherein the clustering comprises comparing pairs of paths based on the respective plurality of metrics and a threshold distance that differs for each path metric of the plurality of path metrics.

5. The method of claim 1, wherein the clustering comprises:
comparing a path in an exploration queue to an outlier path that is not a member of a cluster;
responsive to the path in the exploration queue being sufficiently similar to the outlier path, adding the outlier path to the cluster and the exploration queue.

6. The method of claim 1, wherein the stored set of paths in the routing table excludes one or more paths, of the plurality of paths, that are outliers of the identified cluster.

7. The method of claim 1, wherein the plurality of paths includes a designation of a service provider and connection type for one or more links in the path.

8. The method of claim 1, wherein selecting the preferred path is based on a policy or an application type.

9. The method of claim 1, wherein clustering the plurality of paths is based on a policy or an application type.

10. The method of claim 1, wherein the networking destination is an anycast networking address.

11. A networking device for programming a route in a network, comprising:
a controller configured to:
identify a plurality of paths from a networking source to a networking destination, each path having an associated plurality of path metrics;
determine a preferred path for the networking source to the networking destination based on the plurality of path metrics associated with the preferred path;
cluster the plurality of paths to one or more path clusters based on the respective plurality of path metrics of the respective plurality of paths;
identify a cluster having the preferred path and a set of paths associated with the cluster; and
send the set of paths associated with the cluster for storage in a routing table of a networking device associated with the networking source for sending packets to the networking destination.

12. The networking device of claim 11, wherein the networking device is the networking source and the further comprises the routing table.

13. The networking device of claim 11, wherein the clustering comprises comparing pairs of paths based on the respective plurality of metrics and a threshold distance that differs for each path metric of the plurality of path metrics.

14. The networking device of claim 11, wherein the clustering comprises comparing paths in an exploration queue to outlier paths that are not members of a cluster; and when an explored path is sufficiently similar to an outlier path, adding the outlier path to the cluster and the exploration queue.

15. The networking device of claim 11, wherein the stored set of paths in the routing table excludes one or more paths, of the plurality of paths, that are outliers of the identified cluster.

16. The networking device of claim 11, wherein the networking destination is an anycast networking address.

17. A non-transitory computer-readable medium having instructions executable by a processor for:
identifying a plurality of paths from a networking source to a networking destination, each path having an associated plurality of path metrics;
determining a preferred path for the networking source to the networking destination based on the plurality of path metrics associated with the preferred path;
clustering the plurality of paths with respect to the preferred path into a cluster having a set of paths based on the respective plurality of path metrics of the respective plurality of paths; and
storing the set of paths associated with the cluster in a routing table of the networking source for sending packets to the networking destination.

18. The non-transitory computer-readable medium of claim 17, wherein the instructions are further for:
detecting a condition for re-evaluating the plurality of paths;
in response to detecting the condition, updating the set of paths and storing the updated set of paths for storing the updated set of paths in the routing table.

19. The non-transitory computer-readable medium of claim 18, wherein the condition is a change in network topology, an amount of time since the set of paths were stored in the routing table, or a change in the plurality of path metrics.

20. The non-transitory computer-readable medium of claim 17, wherein the clustering comprises comparing pairs of paths based on the respective plurality of metrics and a threshold distance that differs for each path metric of the plurality of path metrics, wherein the threshold distance decays based on a size of the cluster.
